(19) United States
(12) Patent Application Publication
(10) Pub. No.: US 2007/0037059 A1
(43) Pub. Date: Feb. 15, 2007

(54) Microbattery with at least one electrode and electrolyte each comprising a common grouping (xy1y2y3y4) and method for production of said microbattery

(75) Inventors: Raphael Salot, Lans en Vercors (FR); Frederic Le Cras, Notre Dame de l'Osier (FR); Stephanie Roche, Grenoble (FR)

Correspondence Address: OLIFF & BERRIDGE, PLC, P.O. BOX 19928, ALEXANDRIA, VA, 22320, US

(73) Assignee: Commissariat a l'Energie Atomique, Paris (FR)

(21) Appl. No.: 10/574,511

(22) PCT Filed: Oct. 11, 2004
(86) PCT No.: PCT/FR04/02571

§ 371 Date: Apr. 3, 2006

(30) Foreign Application Priority Data
Oct. 14, 2003 (FR) 031 1998

(51) Int. Cl. H01M 10/36; H01M 4/58; H01M 10/04

(52) U.S. Cl. 429/304; 429/231.5; 429/231.95; 429/223; 429/221; 429/220; 29/623.5

(57) ABSTRACT

A microbattery comprises, in the form of thin layers, at least first and second electrodes between which a solid electrolyte is disposed. The first electrode and the electrolyte both comprise at least one common grouping of [XY₁Y₂Y₃Y₄] type, where X is located in a tetrahedron whose peaks are respectively formed by the chemical elements Y₁, Y₂, Y₃ and Y₄, the chemical element X being selected from the group consisting of phosphorus, boron, silicon, sulphur, molybdenum, vanadium and germanium and the chemical elements Y₁, Y₂, Y₃ and Y₄ being selected from the group consisting of sulphur, oxygen, fluorine and chlorine.

### BACKGROUND OF THE INVENTION

The invention relates to a microbattery comprising, in the form of thin layers, at least first and second electrodes between which a solid electrolyte is disposed.

The invention also relates to a method for production of such a microbattery.

### STATE OF THE ART

Among known microbatteries, certain are based on the principle of insertion and dis-insertion of an alkaline metal ion such as Li⁺ in the positive electrode. The electrochemical behavior of such microbatteries depends to a great extent on the materials constituting the active elements of the microbattery, i.e. of the positive and negative electrodes and of the electrolyte disposed between the two electrodes.

In the case of lithium microbatteries, the negative electrode also called the anode generates Li⁺ ions and is, more often than not, in the form of a thin layer of metallic lithium deposited by thermal evaporation, or made of a lithium-based metal alloy or of a lithium insertion compound such as SiSn_{0.9}ON_{1.9} also called SiTON, SnNₓ, InNₓ, SnO₂.

The positive electrode also called the cathode is formed by at least one material able to insert a certain number of Li⁺ cations in its structure. Thus, materials such as LiCoO₂, LiNiO₂, LiMn₂O₄, CuS, CuS₂, WO_{y}S_{z}, TiO_{y}S_{z}, V₂O₅, V₃O₈ and also the lithium-bearing forms of vanadium oxides and metallic sulphurs are known to have a high Li⁺ ion insertion capacity and are therefore frequently used to form the positive electrode. However, for certain materials, thermal annealing is sometimes necessary so as to increase the crystallization of the deposited thin layer and to increase its Li⁺ ion insertion capacity.

The electrolyte which must be a good ion conductor and an electronic insulator is generally formed by a vitreous material the base of which is boron oxide, lithium oxide or lithium salts, or phosphate such as Li_{2.9}PO_{3.3}N_{0.46} better known under the name of LiPON, or Li_{2.9}Si_{0.45}PO_{1.6}N_{1.3} also called LiSiPON. Thus, U.S. Pat. No. 5,597,660 describes a microbattery in the form of thin layers comprising a vanadium oxide cathode, a lithium anode and an electrolyte comprising LiₓPO_{y}N_{z}, with x=2.8, 2y+3z=7.8 and z comprised between 0.16 and 0.46.

Such lithium microbatteries are however known to have a high electrical resistance. Thus in the article “Preferred orientation of polycrystalline LiCoO₂ films” (Journal of Electrochemical Society, 147 (1), 59-70, 2000), J. B. Bates and al. indicate that a battery comprising a LiCoO₂ positive electrode and a Li₃PO₄ solid electrolyte presents a high resistance essentially due to the electrolyte and the interface between the positive electrode and the electrolyte.

In the European Patent application EP-A-1052712, a lithium battery comprises a non-aqueous electrolyte that can be composed of lithium salts dissolved in a non-aqueous solvent, such as LiClO₄ or LiBF₄, or be in solid form such as Li₄SiO₄. The material of the positive electrode can be chosen from the compounds containing lithium such as LiₓMn₂O₄, LiNi_{1-y}M_{y}O_{z}, LiₓMn_{2-y}M_{y}O₄, with M chosen from Na, Mg, Sc, Y, Mn, Fe, Co, Ni, Cu, Zn, Al, Cr, Pb, Sb and B and x comprised between 0 and 1, y comprised between 0 and 0.9 and z comprised between 2 and 2.3. The material of the negative electrode is formed by composite particles comprising a first solid phase containing at least one element chosen from Sn, Si and Zn and deposited on a second solid phase for example composed of a solid solution or of an intermetallic compound. To improve the performances of the battery, the composite particles preferably comprise an element in the form of traces and chosen from iron, lead and bismuth. This is however not sufficient to reduce the internal electrical resistance of the battery.

### OBJECT OF THE INVENTION

It is an object of the invention to provide a microbattery presenting a high energy storage capacity and a moderate electrical resistance.

According to the invention, this object is achieved by the fact that the first electrode and the electrolyte both comprise at least one common grouping of the [XY₁Y₂Y₃Y₄] type, where X is located in a tetrahedron whose peaks are respectively formed by the chemical elements Y₁, Y₂, Y₃ and Y₄, the chemical element X being chosen from phosphorus, boron, silicon, sulphur, molybdenum, vanadium and germanium and the chemical elements Y₁, Y₂, Y₃ and Y₄ being chosen from sulphur, oxygen, fluorine and chlorine.

According to a development of the invention, the electrolyte comprises an alkaline metal ion A chosen from lithium and sodium.

According to a particular embodiment, the first electrode comprises the alkaline metal ion A, a mixture of metallic ions T comprising at least one transition metal ion chosen from titanium, vanadium, chromium, cobalt, nickel, manganese, iron, copper, niobium, molybdenum and tungsten and a chemical element B chosen from sulphur, oxygen, fluorine and chlorine, so as to form a compound of the Aₓ₁T_{y1}[XY₁Y₂Y₃Y₄]_{z1}B_{w1} type, with the [XY₁Y₂Y₃Y₄] grouping, with x₁ and w₁≧0 and y₁ and z₁>0, a chemical element E chosen from metals and carbon being dispersed in the compound.

According to another feature of the invention, the second electrode comprises at least one grouping of [X′Y′₁Y′₂Y′₃Y′₄] type, where X′ is located in a tetrahedron whose peaks are respectively formed by the chemical elements Y′₁, Y′₂, Y′₃ and Y′₄, the chemical element X′ being chosen from phosphorus, boron, silicon, sulphur, molybdenum, vanadium and molybdenum and the chemical elements Y′₁, Y′₂, Y′₃ and Y′₄ being chosen from sulphur, oxygen, fluorine and chlorine.

More particularly, the second electrode comprises the alkaline metal ion A, a mixture of metallic ions T′ comprising at least one transition metal ion chosen from titanium, vanadium, chromium, cobalt, nickel, manganese, iron, copper, niobium, molybdenum and tungsten and a chemical element B′ chosen from sulphur, oxygen, fluorine and chlorine, so as to form a compound of Aₓ₂T′_{y2}[X′Y′₁Y′₂Y′₃Y′₄]_{z2}B′_{w2} type, with the [X′Y′₁Y′₂Y′₃Y′₄] grouping, with x₂ and w₂≧0 and y₂ and z₂>0, a chemical element E′ chosen from metals and carbon being dispersed in the compound so that the first and second electrodes have different intercalation potentials of the alkaline metal ion A.

It is also an object of the invention to provide a method for production of such a microbattery that is easy to implement, preferably, by means of the vacuum thin layer deposition techniques used in the microtechnologies field.

According to the invention, this object is achieved by the fact that the method consists in successively depositing on a substrate:
a first thin layer forming the second electrode by means of a first sputtering target comprising at least the compound of Aₓ₂T′_{y2}[XY₁Y₂Y₃Y₄]_{z2}B′_{w2} type and the chemical element E′,
a second thin layer forming the electrolyte (4) by means of a second sputtering target comprising at least the grouping of [XY₁Y₂Y₃Y₄] type,
and a third thin layer forming the first electrode by means of a third sputtering target comprising at least the grouping of Aₓ₁T_{y1}[XY₁Y₂Y₃Y₄]_{z1}B_{w1} type and the chemical element E.

### BRIEF DESCRIPTION OF THE DRAWINGS

Other advantages and features will become more clearly apparent from the following description of particular embodiments of the invention given as non-restrictive examples only and represented in the accompanying drawings, in which:

FIG. 1 represents a first embodiment of a microbattery according to the invention, in cross-section.

FIG. 2 represents a second embodiment of a microbattery according to the invention, in cross-section.

### DESCRIPTION OF PARTICULAR EMBODIMENTS

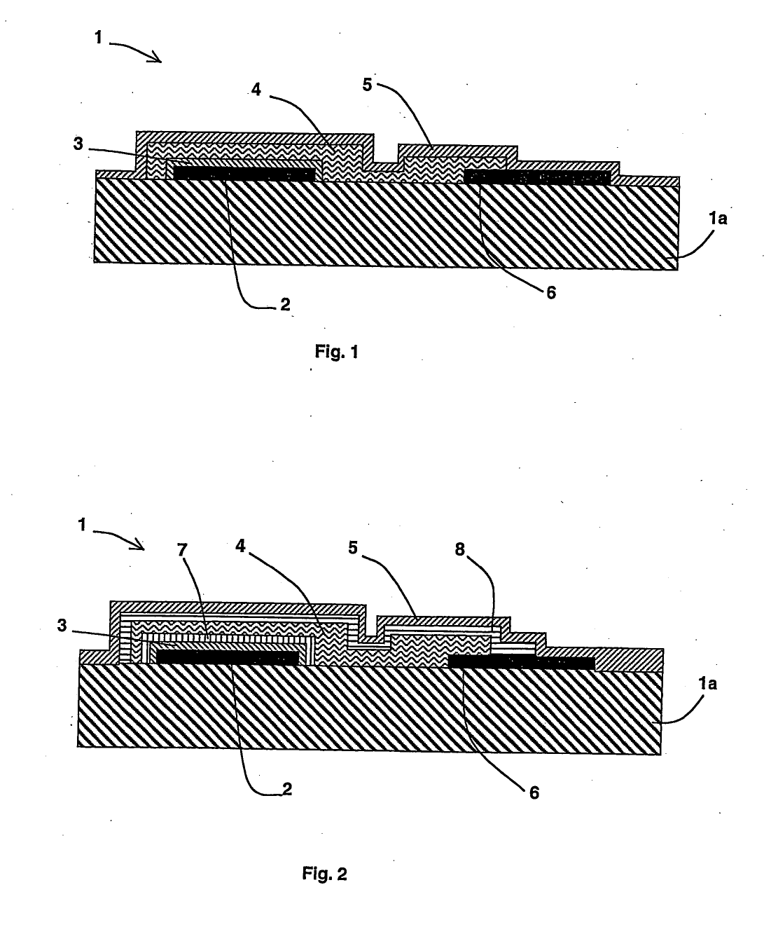

As illustrated in FIG. 1, a microbattery 1 comprises a substrate 1a on which first and second metal current collectors 2 and 6 are arranged. The current collectors are for example made of platinum, chromium, gold or titanium and they preferably have a thickness comprised between 0.1 μm and 0.3 μm.

The first current collector 2 is totally covered by an electrode forming the cathode 3 so that the latter surrounds the first current collector 2 and a thin layer forming the electrolyte 4 is deposited so as to cover the cathode 3, the part of the substrate 1a separating the first and second current collectors 2 and 6 and a part of the second collector 6. Another electrode forming the anode 5 is arranged so as to be in contact with the substrate 1a, the electrolyte 4 and the free part of the second current collector 6. The anode and cathode each preferably have a thickness comprised between 0.1 μm and 15 μm.

At least one of the two electrodes and the electrolyte 4 each comprise a common grouping of [XY₁Y₂Y₃Y₄] type, where X is located in a tetrahedron whose peaks are respectively formed by the chemical elements Y₁, Y₂, Y₃ and Y₄. The chemical element X is chosen from phosphorous, boron, silicon, sulphur, molybdenum, vanadium and germanium and the chemical elements Y₁, Y₂, Y₃ and Y₄ are chosen from sulphur, oxygen, fluorine and chlorine. The elements Y₁, Y₂, Y₃ and Y₄ can be identical and at least one of these elements can form a peak common to two tetrahedra so as to form a condensed compound.

The fact that at least one of the two electrodes and the electrolyte each comprise a common grouping in particular enables a certain continuum or a certain homogeneity to be created in the chemical composition of the superposed thin layers. The interface between the electrode and the electrolyte then has a low electrical resistance with respect to thin layers of different chemical compositions and different structures. This enables in particular the total electrical resistance of the microbattery to be reduced and its energy storage capacity to be improved.

The solid electrolyte 4 preferably comprises an alkaline metal ion A chosen from lithium and sodium. It then comprises at least one compound of AXY₁Y₂Y₃Y₄ type and it preferably has a thickness comprised between 0.5 μm and 1.5 μm. The electrolyte 4 can for example comprise lithium phosphate (Li₃PO₄). The electrolyte 4 can also be formed by a mixture of compounds among which a compound of AXY₁Y₂Y₃Y₄ type. The electrolyte 4 can thus be formed by a mixture of Li₃PO₄ with a compound comprising lithium such as Li₂SiO₃ or Li₄SiO₄ or Li₂S or with a compound comprising silicon such as SiS₂. It can also comprise nitrogen, which partially replaces a Y₁, Y₂, Y₃, or Y₄ element of the group [XY₁Y₂Y₃Y₄], forming, for example in the case of an electrolyte made of Li₃PO₄, LiₓPO_{y}N_{z}, the nitrogen giving the electrolyte a good ionic conductivity.

When the electrolyte comprises an alkaline metal ion A, the electrode forming the cathode 3 is preferably designed for insertion and dis-insertion of the alkaline metal ion A whereas the electrode forming the anode 5 is preferably designed to supply the alkaline metal ion. The anode and cathode have different intercalation potentials of the alkaline metal ion A.

In a particular embodiment, the electrode forming the anode 5 comprises the grouping of [XY₁Y₂Y₃Y₄] type. It generally also comprises the alkaline metal ion A contained in the electrolyte 4, a mixture of metallic ions T, a chemical element B chosen from sulphur, oxygen, fluorine and chlorine and a chemical element E. The mixture of metallic ions T comprises at least one transition metal ion chosen from titanium, vanadium, chromium, cobalt, nickel, manganese, iron, copper, niobium, molybdenum and tungsten. Thus, the electrode comprises a compound of Aₓ₁T_{y1}[XY₁Y₂Y₃Y₄]₁B_{w1}, type with x₁ and w₁≧0 and y₁ and z₁>0, a chemical element E chosen from metals and carbon being dispersed in the compound. For example, in the case of a Li₃PO₄ electrolyte, the anode can for example be formed by LiFePO₄ in which platinum is dispersed (also noted LiFePO₄,Pt). The LiFePO₄, Pt material of the negative electrode can advantageously be replaced by LiFe_{0.67}PO₄, Au.

The cathode 3 can be formed by any type of materials known to be used as cathode in this type of microbattery. It can for example be formed by the alkaline metal A or an alloy of the alkaline metal A or by a material able to be alloyed with the alkaline metal A, such as silicon, carbon or tin, or it can be formed by a mixed chalcogenide comprising a transition metal.

It can also be formed by at least one grouping of [X′Y′₁Y′₂Y′₃Y′₄] type where X′ is located in a tetrahedron whose peaks are respectively formed by the chemical elements Y′₁, Y′₂, Y′₃ and Y′₄, the chemical element X′ being chosen from phosphorous, boron, silicon, sulphur, molybdenum, vanadium and molybdenum and the chemical elements Y′₁, Y′₂, Y′₃ and Y′₄ being chosen from sulphur, oxygen, fluorine and chlorine. Thus, more particularly, the cathode also comprises the alkaline metal ion A, a mixture of metallic ions T′ comprising at least one transition metal ion chosen from titanium, vanadium, chromium, cobalt, nickel, manganese, iron, copper, niobium, molybdenum and tungsten and a chemical element B′ chosen from sulphur, oxygen, fluorine and chlorine. It then comprises a compound of Aₓ₂T′_{y2}[X′Y′₁Y′₂Y′₃Y′₄]_{z2}B′_{w2}, type with x₂ and w₂≧0 and y₂ and z₂>0, a chemical element E′ chosen from metals and carbon being dispersed in the compound.

The elements T and T′ can be identical as can the elements E and E′ that are designed to ensure a good electronic conductivity in the electrodes. Likewise, the elements X′, Y′₁, Y′₂, Y′₃, Y′₄ can be identical to the elements X, Y₁, Y₂, Y₃, Y₄. In this case, a continuum also exists in the chemical composition of the electrolyte and of the cathode, which further reduces the total electrical resistance of the microbattery and improves the energy storage capacity.

The anode and cathode always have different intercalation potentials of the alkaline metal ion A. Thus, either the transition metals T and T′ are different and in this first case they have different Fermi levels, or the transition metals T and T′ are identical, and in this second case the transition metal is associated differently with the [XY₁Y₂Y₃Y₄] group in the two materials, i.e. y1 and y2 are different. Likewise, to preserve a continuum in the chemical composition of the microbattery, the electrolyte can comprise the [X′Y′₁Y′₂Y′₃Y′₄] and [XY₁Y₂Y₃Y₄] groupings, in the case where the elements X′, Y₁′, Y′₂, Y′₃, Y′₄ are respectively different from the elements X, Y₁, Y₂, Y₃, Y₄.

For example, in a microbattery according to FIG. 1, the anode 5 is formed by LiFePO₄ in which platinum is inserted (also noted LiFePO₄,Pt), the cathode 3 is made of LiCoPO₄ in which platinum is inserted (also noted LiCoPO₄,Pt), and the electrolyte 4 is made of Li₃PO₄.

According to another example, the anode 5 can be formed by the compound LiVSi₂O₆, the electrolyte 4 and cathode 3 being respectively made of Li₄SiO₄Li₃BO₃ and of LiCoO₂. In this case, the grouping common to the anode 5 and to the electrolyte 4 is SiO₄, the compound LiVSi₂O₆ comprising SiO₄ groupings in its structure.

Such a microbattery, such as the one represented in FIG. 1, is preferably achieved by successively depositing on the substrate, which can for example be made of silicon:
a first thin layer forming the cathode 3, by means of a first sputtering target comprising at least the compound of Aₓ₂T′_{y2}[XY₁Y₂Y₃Y₄]_{z2}B′_{w2} type and the chemical element E′.
a second thin layer forming the electrolyte 4, by means of a second sputtering target comprising at least the grouping of [XY₁Y₂Y₃Y₄] type and able to be deposited in the presence of gaseous nitrogen,
and a third thin layer forming the anode 5, by means of a third sputtering target comprising at least the grouping of Aₓ₁T_{y1}[XY₁Y₂Y₃Y₄]_{z1}B_{w1} type and the chemical element E.

The first and second current collectors 2 and 6 are preferably deposited on the substrate 1a, by cathode sputtering, before deposition of the cathode 3.

In an alternative embodiment represented in FIG. 2, an intermediate thin layer 7 comprising the respective constituents of the cathode 3 and of the electrolyte 4 is arranged between the cathode 3 and the electrolyte 4 so as to totally cover the cathode 3. The concentrations of the constituents of the cathode 3 and of the constituents of the electrolyte 4 vary respectively from 0 to 1 and from 1 to 0, from the electrolyte to the cathode. Thus, the first thin layer 7 comprises first and second concentration gradients, respectively of the constituents of the cathode and of the constituents of the electrolyte, the first and second gradients being respectively decreasing and increasing from the electrolyte to the cathode.

In the same way, the microbattery represented in FIG. 2 comprises an additional intermediate thin layer 8 comprising the respective constituents of the anode 5 and of the electrolyte. It is disposed between the anode 5 and the electrolyte 4, the concentrations of the constituents of the anode and of the electrolyte varying respectively from 0 to 1 and from 1 to 0, from the electrolyte to the anode. For example, for an electrolyte made of Li₃PO₄, a LiFePO₄, Pt anode and a LiCoPO₄, Pt cathode, the intermediate thin layer 7 comprises the compound Li₃PO₄ and the compound LiCoPO₄, Pt whereas the additional intermediate thin layer 8 comprises the compound Li₃PO₄ and the compound LiFePO₄, Pt.

Arranging an intermediate thin layer comprising the same constituents as the electrode and the electrolyte between an electrode and the electrolyte enables the concentration gradient to be reduced in [XY₁Y₂Y₃Y₄] grouping for the anode and in [X′Y′₁Y′₂Y′₃Y′₄] grouping for the cathode, in the whole of the electrode-electrolyte-electrode stacking, and therefore enables the electrical resistance at the interfaces to be reduced, which reduces the total electrical resistance of the microbattery.

To achieve a microbattery such as the one represented in FIG. 2, the intermediate thin layer 7 is deposited on the cathode by means of the first and second sputtering targets, before deposition of the electrolyte. A sputtering power gradient for the two targets can be used so as to obtain a concentration gradient of the constituents of the cathode and of the electrolyte in the intermediate thin layer or the sputtering targets can be sputtered by an alternation of very fast flashes. In the same way, the additional intermediate thin layer 8 is deposited on the electrolyte by means of the second and third sputtering targets, before deposition of the first electrode.

Furthermore, when the thin layers are deposited on the substrate, the latter can be animated by a rotation movement making it pass alternately in front of each of the targets, the time it spends in front of each target varying according to the thickness of the thin layer to be deposited.

Thus for example, a microbattery is achieved by a thin layer vacuum deposition technique called radiofrequency magnetron sputtering deposition, on a silicon substrate having a surface of 1 cm². Thus, the first platinum collector 2 is deposited on the substrate through a mask, then the cathode 3 is formed with a first sputtering target comprising 99% LiCoPO₄ and 1% platinum. An intermediate thin layer 7 is then deposited on the cathode, respectively by means of the first target and of a second target formed by Li₃PO₄. The electrolyte 4 is formed on the intermediate thin layer 7 by means of the second target, preferably in the presence of gaseous nitrogen, and it has a thickness of 1 μm.

Then an additional intermediate thin layer 8 is deposited on the electrolyte 4 by means of a third target comprising 99% FePO₄ and 1% platinum and of the second target. The anode 5 is then deposited on the additional intermediate thin layer 8 by means of the third target. The cathode and anode each have a thickness of 1.5 μm. Such a microbattery delivers a voltage of 1.4V.

Such a production method not only enables a microbattery having a relatively homogeneous chemical composition to be obtained, but also enables thin layer deposition techniques used in the microtechnology field to be implemented, and in particular by cathode sputtering. Such a microbattery can thus be integrated in microsystems such as smart cards or smart labels.

Such a microbattery also presents the advantage of not using a negative electrode made of metallic lithium. The alkaline metal is in fact generally deposited by thermal evaporation which requires turning of the substrate which could damage the microbattery. The total thickness of the battery can vary between 0.3 and 0.30 μm, a small thickness enabling high current densities to be withstood at low capacitance whereas a large thickness enables a large capacitance at low current.

The invention is not limited to the embodiments described above. Thus, in the method for production of a microbattery according to the invention, the depositions of the anode and of the cathode can be reversed. Furthermore, deposition of the thin layers can also be performed by a co-sputtering technique, making the power imposed on each target vary in time.

1-23. (canceled)

24. Microbattery comprising, in the form of thin layers, at least first and second electrodes between which a solid electrolyte is disposed, wherein the first electrode and the electrolyte both comprise at least one common grouping of the [XY₁Y₂Y₃Y₄] type, where X is located in a tetrahedron whose peaks are respectively formed by the chemical elements Y₁, Y₂, Y₃ and Y₄, the chemical element X being selected from the group consisting of phosphorus, boron, silicon, sulphur, molybdenum, vanadium and germanium and the chemical elements Y₁, Y₂, Y₃ and Y₄ being selected from the group consisting of sulphur, oxygen, fluorine and chlorine.

25. Microbattery according to claim 24, wherein the chemical elements Y₁, Y₂, Y₃ and Y₄ are identical.

26. Microbattery according to claim 24, wherein at least one chemical element selected from the group consisting of Y₁, Y₂, Y₃ and Y₄ forms a peak common to two tetrahedra.

27. Microbattery according to claim 24, wherein the electrolyte comprises nitrogen.

28. Microbattery according to claim 24, wherein the electrolyte comprises an alkaline metal ion A selected from the group consisting of lithium and sodium.

29. Microbattery according to claim 28, wherein the first electrode comprises the alkaline metal ion A, a mixture of metallic ions T comprising at least one transition metal ion selected from the group consisting of titanium, vanadium, chromium, cobalt, nickel, manganese, iron, copper, niobium, molybdenum and tungsten and a chemical element B selected from the group consisting of sulphur, oxygen, fluorine and chlorine, so as to form a compound of Aₓ₁T_{y1}[XY₁Y₂Y₃Y₄]_{z1}B_{w1} type with the [XY₁Y₂Y₃Y₄] grouping, with x₁ and w₁≧0 and y₁ and z₁>0, a chemical element E selected from the group consisting of metals and carbon being dispersed in the compound.

30. Microbattery according to claim 29, wherein the second electrode comprises at least one grouping of the [X′Y′₁Y′₂Y′₃Y′₄] type, where X′ is located in a tetrahedron whose peaks are respectively formed by the chemical elements Y′₁, Y′₂, Y′₃ and Y′₄, the chemical element X′ being selected from the group consisting of phosphorus, boron, silicon, sulphur, molybdenum, vanadium and germanium and the chemical elements Y′₁, Y′₂, Y′₃ and Y′₄ being selected from the group consisting of sulphur, oxygen, fluorine and chlorine.

31. Microbattery according to claim 30, wherein the second electrode comprises the alkaline metal ion A, a mixture of metallic ions T′ comprising at least one transition metal ion selected from the group consisting of titanium, vanadium, chromium, cobalt, nickel, manganese, iron, copper, niobium, molybdenum and tungsten and a chemical element B′ selected from the group consisting of sulphur, oxygen, fluorine and chlorine, so as to form a compound of Aₓ₂T′_{y2}[X′Y′₁Y′₂Y′₃Y′₄]_{z2}B′_{w2} type, with the [X′Y′₁Y′₂Y′₃Y′₄] grouping, with x₂ and w₂≧0 and y₂ and z₂>0, a chemical element E′ selected from the group consisting of metals and carbon being dispersed in the compound so that the first and second electrodes have different intercalation potentials of the alkaline metal ion.

32. Microbattery according to claim 31, wherein T and T′ are identical.

33. Microbattery according to claim 31, wherein E and E′ are identical.

34. Microbattery according to claim 30, wherein the electrolyte comprises the groupings [XY₁Y₂Y₃Y₄] and [X′Y′₁Y′₂Y′₃Y′₄].

35. Microbattery according to claim 30, wherein the elements X′, Y′₁, Y′₂, Y′₃ and Y′₄ are respectively identical to the elements X, Y₁, Y₂, Y₃ and Y₄.

36. Microbattery according to claim 29, wherein the second electrode is formed by the alkaline metal or an alloy of the alkaline metal.

37. Microbattery according to claim 29, wherein the second electrode is formed by a material able to be alloyed with the alkaline metal.

38. Microbattery according to claim 29, wherein the material able to be alloyed with the alkaline metal is made of silicon, carbon or tin.

39. Microbattery according to claim 29, wherein the second electrode is formed by a mixed chalcogenide comprising a transition metal.

40. Microbattery according to claim 34, wherein a first intermediate thin layer comprising the respective constituents of the first electrode and of the electrolyte is arranged between the first electrode and the electrolyte, the concentrations of the constituents of the first electrode and of constituents of the electrolyte varying respectively from 0 to 1 and from 1 to 0, from the electrolyte to the first electrode.

41. Microbattery according to claim 40, wherein a second intermediate thin layer comprising the respective constituents of the second electrode and of the electrolyte is arranged between the second electrode and the electrolyte, the concentrations of the constituents of the second electrode and of the electrolyte varying respectively from 0 to 1 and from 1 to 0, from the electrolyte to the second electrode.

42. Method for production of a microbattery according to claim 35, consisting in successively depositing on a substrate:
a first thin layer forming the second electrode by means of a first sputtering target comprising at least the compound of Aₓ₂T′_{y2}[XY₁Y₂Y₃Y₄]_{z2}B′_{w2} type and the chemical element E′,
a second thin layer forming the electrolyte by means of a second sputtering target comprising at least the grouping of [XY₁Y₂Y₃Y₄] type,
and a third thin layer forming the first electrode by means of a third sputtering target comprising at least the grouping of Aₓ₁T_{y1}[XY₁Y₂Y₃Y₄]_{z1}B_{w1} type and the chemical element E.

43. Method for production of a microbattery according to claim 42, wherein a first intermediate thin layer is deposited on the second electrode by means of the first and second sputtering targets before deposition of the electrolyte.

44. Method for production of a microbattery according to claim 43, wherein a second intermediate thin layer is deposited on the electrolyte by means of the second and third sputtering targets before deposition of the first electrode.

45. Method for production of a microbattery according to claim 42, wherein the electrolyte is deposited in the presence of gaseous nitrogen.

46. Method for production of a microbattery according to claim 42, wherein first and second current collectors are deposited on the substrate, by cathode sputtering, before deposition of the second electrode.
